(19) United States
(12) Patent Application Publication
(10) Pub. No.: US 2023/0412203 A1
(43) Pub. Date: Dec. 21, 2023

(54) RECEIVER DESENSE MITIGATION

(71) Applicant: Apple Inc., Cupertino, CA (US)

(72) Inventors: Sharad Sambhwani, San Diego, CA (US); Apurva Pande, San Jose, CA (US); Dirk Nickisch, Oberpframmern (DE); Pallavi Suresh Mastiholimath, Santa Clara, CA (US); Prashanthan Pathamadai Krishnan, San Jose, CA (US); Sairamm Prabakar, San Jose, CA (US); Sanjeevi Balasubramanian, San Jose, CA (US); Sriram Krishnan, San Jose, CA (US)

(21) Appl. No.: 17/841,576

(22) Filed: Jun. 15, 2022

(51) Int. Cl. H04B 1/10

(52) U.S. Cl. CPC H04B 1/1027

(57) ABSTRACT

Embodiments herein provide various apparatuses and techniques to for enhanced handling of receiver desensitization, “desense,” in electronic devices that is caused by an operation of the device. In an embodiment, sensitivity of a receiver affected by desense may be determined based on receiver sensitivity without desense and a desense offset value. Desense mitigation measures may be applied based on the strength of the signal received by the receiver being less than the receiver sensitivity affected by desense. The desense mitigation measures may include deactivating the device operation that causes desense, enabling the device operation that causes desense only during certain times, and enabling antenna diversity. In some embodiments, various power and signal-to-noise ratio thresholds may be used for conditional application of different desense mitigation measures. For example, to enable receiver diversity on the device, strength of the signal needs to be below one power threshold and above another power threshold.

### BACKGROUND

The present disclosure relates generally to wireless communication and, more specifically, to mitigating desense (e.g., receiver sensitivity degradation) impacts on wireless technology.

In an electronic device, sensitivity of a receiver may degrade due to noise sources generated within the device. For example, in a smartphone, receiver sensitivity to low band wireless signals (e.g., cellular LTE signals) may degrade when fast or accelerated charging of a power source (e.g., a battery) is performed. Currently, techniques for mitigating receiver sensitivity degradation include disabling the noise sources regardless of whether strength of a signal received at the receiver is sufficiently high to successfully transmit data, even if receiver sensitivity is reduced. In certain cases, disabling the noise source may deactivate or block important operations of the electronic device, thereby hindering user experience.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic device comprises a receiver that receives a signal having a frequency and a processing circuitry coupled to the receiver. The processing circuitry may receive a desense offset value based on an operation of the electronic device that decreases sensitivity of the receiver for the frequency, apply a desense mitigation procedure based on a signal strength of the signal received at the receiver, the sensitivity of the receiver, and the desense offset value, and cause the receiver to receive a signal.

In another embodiment, a method comprises determining, via processing circuitry of a receiving device, that an operation of the receiving device decreases sensitivity of a receiver of the receiving device for a frequency as well as receiving, via the processing circuitry, a desense offset value based on the operation of the receiving device. The method further comprises determining, via the processing circuitry, an adjusted sensitivity of the receiver based on the sensitivity of the receiver and the desense offset value, applying, via the processing circuitry, a desense mitigation procedure based on a signal strength at the receiver and the adjusted sensitivity, and causing, via the processing circuitry, the receiver to receive a signal.

In yet another embodiment, one or more tangible, non-transitory, computer-readable media comprises instructions that cause processing circuitry of a receiving device to receive a desense offset value based on an operation of the receiving device, cause the receiver to determine a sensitivity of the receiver, and determine an adjusted sensitivity based on the sensitivity and the desense offset value. In addition, the instructions cause the processing circuitry of the receiving device to apply a desense mitigation procedure based on a signal strength at the receiver and the adjusted sensitivity as well as cause the receiver to receive a signal.

In one embodiment, an electronic device comprises a first receiver, a second receiver, and a processing circuitry coupled to the first receiver and the second receiver. The processing circuitry is configured to cause the first receiver of the electronic device to receive a first signal with a frequency and apply a desense mitigation procedure based on a power level of the first signal being greater than or equal to a low power threshold and less than a medium power threshold. In addition, the processing circuitry is configured to cause the first receiver and the second receiver to receive a second signal based on the power level of the first signal being greater than or equal to the medium power threshold and less than a high power threshold. The processing circuitry is also configured to apply the desense mitigation procedure based on the power level of the first signal being greater than or equal to the medium power threshold and less than the high power threshold and based on a signal-to-noise ratio of the second signal being less than a signal-to-noise ratio threshold.

In another embodiment, one or more tangible, non-transitory, computer-readable media comprises instructions that cause processing circuitry of a receiving device to cause a first receiver of the receiving device to receive a first signal with a first frequency and apply a first desense mitigation procedure based on a strength level of the first signal being greater than or equal to a low strength threshold and less than a medium strength threshold. In addition, the instructions cause the processing circuitry to cause the first receiver and a second receiver to receive a second signal with the first frequency based on the strength level of the first signal being greater than or equal to the medium strength threshold and less than a high strength threshold. Further, the instructions cause the processing circuitry to apply a second desense mitigation procedure based on the strength level of the first signal being greater than or equal to the medium strength threshold and less than the high strength threshold and based on a signal-to-noise ratio of the second signal being less than a signal-to-noise ratio threshold.

In yet another embodiment, one or more tangible, non-transitory, computer-readable media comprises instructions that cause processing circuitry of a receiving device to cause a first receiver of a receiving device to receive a first signal and not process the first signal based on a power level of the first signal being less than a low power threshold. In addition, the instructions cause the processing circuitry to cause the first receiver and a second receiver to receive a second signal based on the power level of the first signal being greater than or equal to a medium power threshold and less than a high power threshold. The instructions also cause the processing circuitry to apply a desense mitigation procedure based on the power level of the first signal being greater than or equal to the medium power threshold and less than the high power threshold and based on a signal-to-noise ratio of the second signal being less than a signal-to-noise ratio threshold.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a transmitter of the electronic device of FIG. 1, according to embodiments of the present disclosure;

FIG. 4 is a schematic diagram of a receiver of the electronic device of FIG. 1, according to embodiments of the present disclosure;

FIG. 5 is a schematic diagram of two signal strength ranges of a signal received by the receiver of FIG. 4, according to embodiments of the present disclosure;

FIG. 6 is a flowchart of a method for mitigating desense impacts on the receiver of FIG. 4, according to embodiments of the present disclosure;

FIG. 7 is a flowchart of a method for mitigating desense impacts on the receiver of FIG. 4 caused by fast charging, according to embodiments of the present disclosure;

FIG. 8. is a schematic diagram of signal strength ranges for which to apply desense mitigation techniques, according to embodiments of the present disclosure;

FIG. 9 is a graph of signal strength thresholds corresponding to the signal strength ranges illustrated in FIG. 8, according to embodiments of the present disclosure, and

FIG. 10 is a flowchart of a method for applying different desense mitigation techniques based on strength of a signal received by the receiver of FIG. 4 falling within the thresholds illustrated in FIG. 9, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on.

This disclosure is directed to mitigating desense impacts on wireless technologies, such as wireless communication with a cellular network by an electronic device. In an electronic device (herein, also referred to as “device”), sensitivity of a receiver may degrade due to noise sources generated within the device. Herein, such degradation of receiver sensitivity may be referred to as “desense.” For example, in a smartwatch (e.g., a wearable electronic device), sensitivity to low band radio frequency (RF) signals may cause desense of a receiver of the smartwatch when the smartwatch is undergoing fast (e.g., accelerated) charging. Here, an operation of the device that causes desense (e.g., fast charging) may be referred to as an “aggressor” and the component affected by desense (e.g., the receiver) may be referred to as a “victim.” Desense may cause the receiver to be unable to receive a radio signal (e.g., a weak radio signal) that it might otherwise be able to receive. Currently, desense mitigation solutions include disabling the aggressor once desense is detected, which may negatively affect user experience. For example, to avoid desense of the receiver of the smartwatch, given that the smartwatch is booted up and not in an airplane mode, fast charging may always be disabled when the smartwatch is both charging and receiving low band signal. This limits the opportunities to use fast charging to charge the smartwatch. Alternatively, if an aggressor is prioritized over a victim and no desense mitigation measures are applied, the signal reception range may be reduced for the receiver, which may hinder the wireless communication capability of the device negatively affect user experience.

Embodiments herein provide various apparatuses and techniques to mitigate desense impacts on wireless technologies, which may provide an improvement upon existing desense mitigation techniques and enable or facilitate aggressor-victim coexistence. In one embodiment, sensitivity of a receiver affected by desense may be determined based on receiver sensitivity based on a desense offset. Desense offset is a quantity of signal power that, when applied to the receiver sensitivity, may provide a more accurate representation of the receiver sensitivity (such that a more accurate determination of whether desense mitigation measures need be applied may be made). Different victim and aggressor combinations may have different desense offset values and desense offset values may be determined during, for example, device testing. With desense present, if strength (e.g., power level) of the signal received by the receiver exceeds the actual receiver sensitivity (e.g., the receiver sensitivity with the desense offset applied), the aggressor and the victim may coexist (e.g., the aggressor operation may continue to be performed while the victim receiver may continue to receive signals with sufficient signal quality and/or power) and desense mitigation measures may not be applied. However, if the signal strength is below the receiver sensitivity with the desense offset applied, then desense mitigation methods may be performed to ensure that the receiver may receive signals with sufficient signal quality and/or power.

As discussed herein, the desense mitigation measures may include deactivating or turning off the aggressor, deactivating the aggressor during certain periods of time, and/or changing the receive frequency of the receiver or the frequency of the aggressor. For example, fast charging of a device may act as the aggressor, and, as such, a desense mitigation measure may include disabling fast charging or enabling fast changing only during the times when a signal is not received in a semi-persistent scheduling (SPS) scheme of wireless data transmission. In another example, if a refresh rate of a display of the device acts as the aggressor, the desense mitigation measure may include changing (e.g., decreasing) the refresh rate of the display. In addition, if the aggressor is a transmitter that transmits data (e.g., via one or more antennas), a desense mitigation measure may include transmitter blanking (e.g., having the transmitter transmit “blank” or remove data, replace data with a dummy value or all zeroes, or deactivating the transmitter altogether).

Various power and/or signal-to-noise ratio thresholds may be established for conditional application of desense mitigation measures. For example, if signal strength (e.g., reference signal receive power (RSRP) of the signal) exceeds or is equal to a high threshold 402 (e.g., threshold associated with good coverage), then no desense mitigation measures may be applied because the data carried by the signal is successfully transmitted to the device. If the signal strength exceeds or is equal to a medium threshold (e.g., threshold associated with a safe operating level of the receiver) but is below the high threshold, then receiver diversity (e.g., turning on multiple receivers) on the device may be enabled as a desense mitigation measure. If, with the receiver diversity enabled, the signal strength exceeds or is equal to the threshold indicating good coverage, then no (further) desense mitigation measures may to be applied. If, with the receiver diversity enabled, signal strength is below the high threshold 402 but the signal-to-noise ratio (SNR) exceeds or is equal to an SNR threshold (e.g., indicating an acceptable level of noise), the aggressor-victim coexistence condition may be met and desense mitigation measures may not be applied. If, on the other hand, the SNR of the signal is below the SNR threshold indicating good coverage, then desense mitigation measures may be applied. Likewise, if the signal strength is below the medium threshold and above or equal to a low threshold (e.g., threshold associated with lowest detectable signal power), then desense mitigation measures may be applied. Finally, if the signal strength is below the low threshold, then the signal may not be processed (e.g., as it is not of sufficient quality).

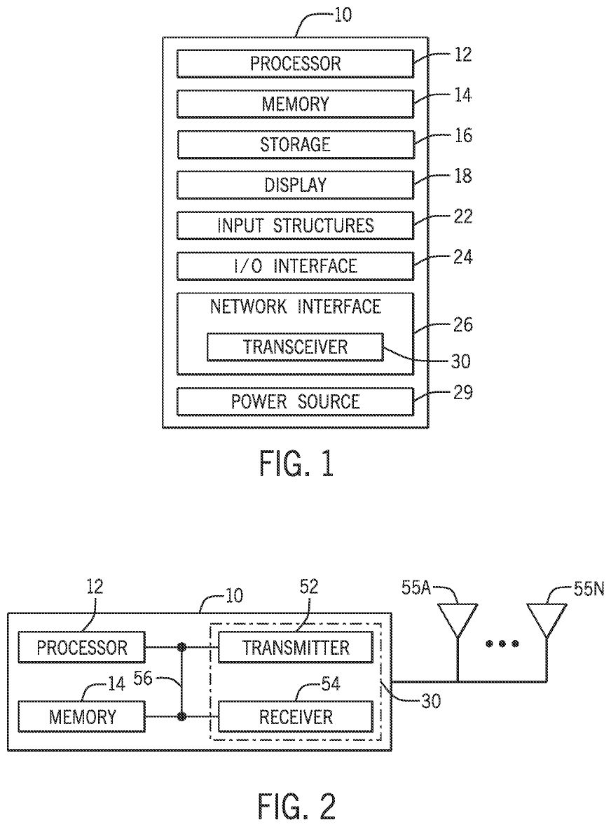

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive data between one another.

The electronic device 10 may include the transmitter 52 and/or the receiver 54 that respectively enable transmission and reception of data between the electronic device 10 and an external device via, for example, a network (e.g., including base stations or access points) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with a one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireless systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

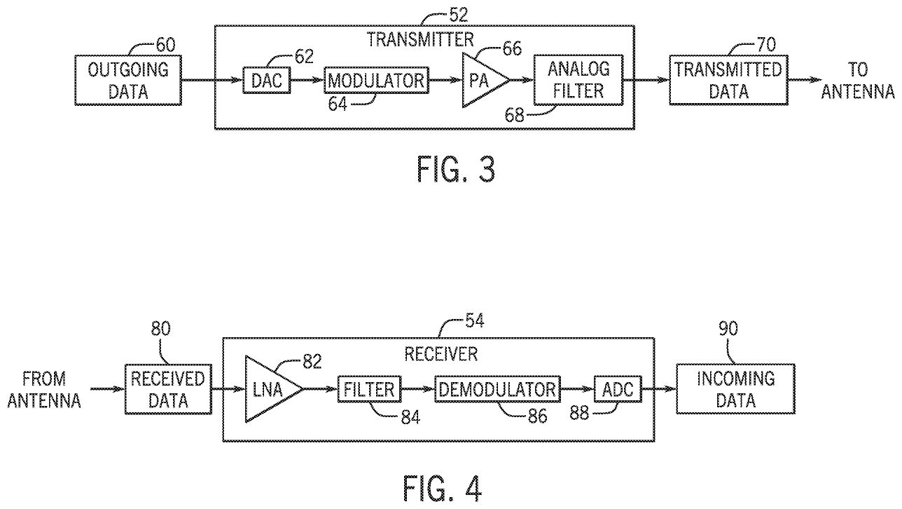

FIG. 3 is a schematic diagram of the transmitter 52 (e.g., transmit circuitry), according to embodiments of the present disclosure. As illustrated, the transmitter 52 may receive outgoing data 60 in the form of a digital signal to be transmitted via the one or more antennas 55. A digital-to-analog converter (DAC) 62 of the transmitter 52 may convert the digital signal to an analog signal, and a modulator 64 may combine the converted analog signal with a carrier signal to generate a radio wave. A power amplifier (PA) 66 receives the modulated signal from the modulator 64. The power amplifier 66 may amplify the modulated signal to a suitable level to drive transmission of the signal via the one or more antennas 55. A filter 68 (e.g., filter circuitry and/or software) of the transmitter 52 may then remove undesirable noise from the amplified signal to generate transmitted data 70 to be transmitted via the one or more antennas 55. The filter 68 may include any suitable filter or filters to remove the undesirable noise from the amplified signal, such as a bandpass filter, a bandstop filter, a low pass filter, a high pass filter, and/or a decimation filter. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the filter 68 if the power amplifier 66 outputs the amplified signal in or approximately in a desired frequency range (such that filtering of the amplified signal may be unnecessary).

FIG. 4 is a schematic diagram of the receiver 54 (e.g., receive circuitry), according to embodiments of the present disclosure. As illustrated, the receiver 54 may receive received data 80 from the one or more antennas 55 in the form of an analog signal. A low noise amplifier (LNA) 82 may amplify the received analog signal to a suitable level for the receiver 54 to process. A filter 84 (e.g., filter circuitry and/or software) may remove undesired noise from the received signal, such as cross-channel interference. The filter 84 may also remove additional signals received by the one or more antennas 55 that are at frequencies other than the desired signal. The filter 84 may include any suitable filter or filters to remove the undesired noise or signals from the received signal, such as a bandpass filter, a bandstop filter, a low pass filter, a high pass filter, and/or a decimation filter. A demodulator 86 may remove a radio frequency envelope and/or extract a demodulated signal from the filtered signal for processing. An analog-to-digital converter (ADC) 88 may receive the demodulated analog signal and convert the signal to a digital signal of incoming data 90 to be further processed by the electronic device 10. Additionally, the receiver 54 may include any suitable additional components not shown, or may not include certain of the illustrated components, such that the receiver 54 may receive the received data 80 via the one or more antennas 55. For example, the receiver 54 may include a mixer and/or a digital down converter.

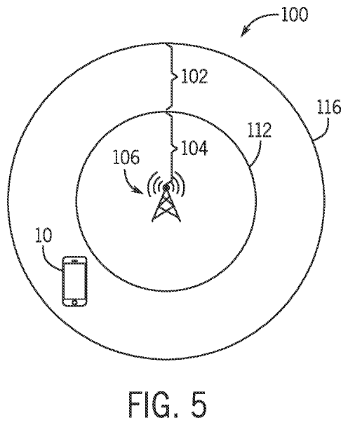

FIG. 5 is a schematic diagram 100 of two signal strength ranges of a signal received by the receiver 54 of FIG. 4, according to embodiments of the present disclosure. The two signal strength ranges, inner range 104 and outer range 102, correspond to distance ranges from or network coverage ranges of the base station 106. FIG. 5 represents a scenario where a device 10 may move closer to or further away from the base station 106, and particularly traveling between the two signal strength ranges. The signal strength is highest close to the base station 106 (e.g., in the inner range 104) and gradually weakens further away from the base station 106 (e.g., being the lowest in the outer range 102). When the device 10 is inside outer boundary 116, the device 10 is within a signal coverage range of the base station 106. However, when experiencing desense, the sensitivity of the receiver 54 of the device 10 to the signal from the base station 106 diminishes. Thus, with desense, the signal coverage range of the base station 106, which is defined by the outer boundary 116, shrinks or decreases to the inner range 104 defined by the inner boundary 112. The outer boundary 116 may represent a distance from the base station 106 or a network coverage range of the base station 106 where signal strength equals receiver sensitivity without desense, and the inner boundary 112 may represent a distance from the base station 106 or a network coverage range of the base station 106 where the signal strength equals receiver sensitivity affected by desense (e.g., adjusted receiver sensitivity).

As discussed herein, mitigating desense impact on the receiver 54 of the device 10 may include applying desense mitigation measures only when the receiver 54 does not receive a signal that is strong enough for successful extraction of information from the signal (e.g., when the signal strength is below the receiver sensitivity level). In such cases, desense mitigation measures may be applied if the device 10 is in the outer range 102, where the receiver sensitivity is reduced (e.g., due to desense) below the strength (e.g., power) level of the signal. If the device 10 is in the inner range 104, then the device 10 may be close enough to the base station 106 to receive a sufficiently strong signal, even if the receiver 54 of the device 10 is affected by desense. Applying desense mitigation measures in a signal strength range (e.g., outer range 102) where the signal strength exceeds receiver sensitivity affected by desense provides an improvement upon the existing methods of mitigating desense impact, which may involve disabling or deactivating the aggressor within the outer boundary 116 when desense affects the receiver 54.

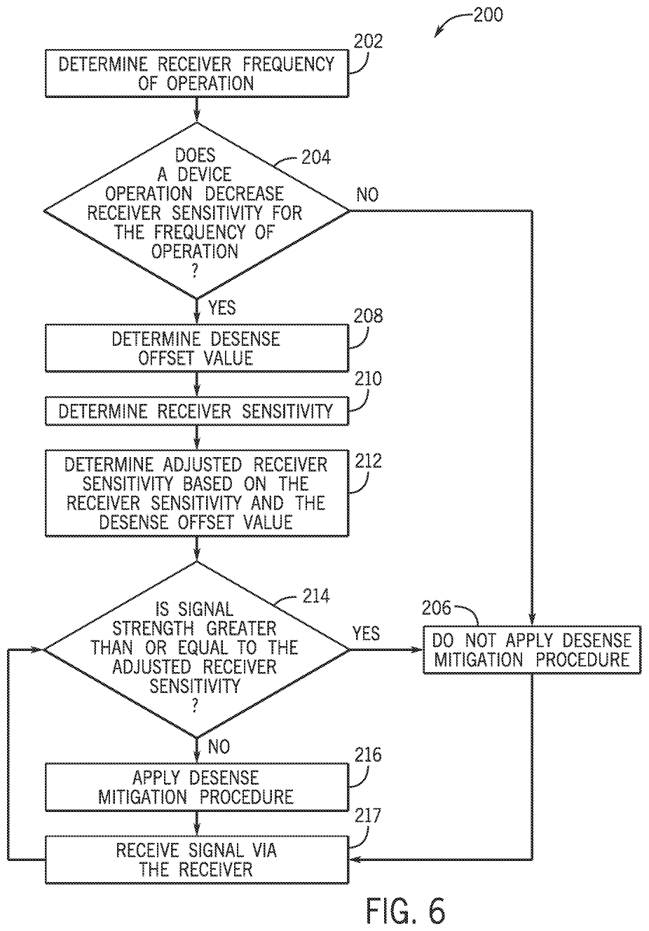

A general process of applying desense mitigation measures in the two signal strength ranges that are identified in FIG. 5 is shown in FIG. 6. FIG. 6 is a flowchart of a method 200 for applying desense mitigation measures based on receiver sensitivity of the receiver 54 of FIG. 4, according to embodiments of the present disclosure. Any suitable device (e.g., a controller) that may control components of the electronic device 10, such as the processor 12, may perform the method 200. In some embodiments, the method 200 may be implemented by executing instructions stored in a tangible, non-transitory, computer-readable medium, such as the memory 14 or storage 16, using the processor 12. For example, the method 200 may be performed at least in part by one or more software components, such as an operating system of the electronic device 10, one or more software applications of the electronic device 10, and the like. While the method 200 is described using steps in a specific sequence, it should be understood that the present disclosure contemplates that the described steps may be performed in different sequences than the sequence illustrated, and certain described steps may be skipped or not performed altogether.

In a process block 202, the processor 12 determines the frequency of operation of the receiver 54. In particular, the frequency of operation of the receiver 54 may be a frequency of a channel that is allocated by the base station 106 on which the signal is sent by the base station 106 and received by the receiver 54. In a process block 204, the processor 12 determines whether an operation of the device 10 decreases the receiver sensitivity for the frequency of operation. Some frequencies of operation may be affected by electromagnetic interference from operations of an electronic device 10, which my decrease the receiver sensitivity (e.g., cause desense). The operations of the device 10 that decrease the receiver sensitivity may be referred to as aggressors. The aggressors may operate on a frequency similar to (e.g., that overlaps with) the operating frequency, or a frequency that generates harmonics similar to (e.g., that overlaps with) the operating frequency of the receiver 54, thus interfering with the received signal. Some examples of possible aggressors in the device 10 include fast charging, intensive usage of memory 14, refreshing of the display 18, usage of the transmitter 52, usage of other circuitry, components, or device operations of the device 10, and so on.

If the receiver sensitivity is not decreased for the frequency of operation, according to a process block 206, desense mitigation procedures are not applied as desense does not impact receiver sensitivity, and, in process block 217, the processor 12 causes the device 10 to receive the signal via the receiver 54. If, on the other hand, an operation does decrease the receiver sensitivity for the frequency of operation, the processor 12 may determine a desense offset value, according to process block 208. The desense offset value may depend on the source of desense (e.g., the aggressor). Different combinations of aggressors (e.g., fast charging, camera usage, memory usage, and the like) and victims (e.g., receivers) may have different desense offset values associated with them. For example, desense offset value for desense of a first receiver 54 due to fast charging may be 15 decibels (dB), while the desense offset value for desense of a second receiver 54 due to camera usage may be 25 dB. Desense offset values may be pre-determined (e.g., determined by the manufacturer during product testing) and stored in the memory 14 (e.g., a lookup table) of the device 10. Thus, when a device operation that causes desense is enabled, the corresponding desense offset values may be retrieved by the processor 12 from the memory 14.

Desense offset value may correspond to the difference between the receiver sensitivity with desense and receiver sensitivity without desense. Desense offset may be expressed in a dimensionless unit (e.g., decibels (dB)) and as a logarithm of a ratio between the receiver sensitivity with desense and receiver sensitivity without desense. In some embodiments, the desense offset value may be based on the worst-case desense impact. For example, operation of the aggressor may produce a decrease in the receiver sensitivity in a range from 5 dB to 20 dB depending on the characteristics of the interfering frequency. In this case, the desense offset value may be stored as 20 dB. The desense offset value includes both an actual desense added to a desense buffer, where actual desense is the actual decrease in sensitivity of a receiver 54 due to noise sources, and the buffer ensures that the desense offset includes the maximum amount of sensitivity loss due a particular noise source.

In a process block 208, the processor 12 determines receiver sensitivity. The receiver sensitivity is the sensitivity of the receiver 54 without desense. The receiver sensitivity may be predetermined (e.g., determined, by the manufacturer, during product testing) and stored in the memory 14 of the device 10.

In a process block 212, the processor 12 determines adjusted receiver sensitivity based on the receiver sensitivity and the desense offset value. The adjusted receiver sensitivity is the sensitivity of the receiver 54 affected by desense. In some cases, the adjusted receiver sensitivity may be referred to as the actual receiver sensitivity. Both the receiver sensitivity and the adjusted receiver sensitivity may be expressed in decibel milliwatts (dBm), a dimensionless unit used to indicate a power level that is expressed in dB with reference to one milliwatt. The adjusted receiver sensitivity relates to the sensitivity of receiver 54 without desense and the desense offset according to Equation 1 below:

Adjusted Receiver Sensitivity=Receiver Sensitivity+Desense Offset (Equation 1)

For example, if the receiver sensitivity without desense is −120 dBm and the desense offset is +20 dB, the adjusted receiver sensitivity under desense may be −100 dBm.

In a process block 214, the processor 12 determines whether strength of the signal received at the receiver 54 is greater than or equal the adjusted receiver sensitivity. This may involve determining the strength of the signal and comparing it to the adjusted receiver sensitivity. If the signal strength is greater than or equal to the adjusted receiver sensitivity, then the processor 12 may not apply desense mitigation procedures, according to process block 206, as the signal is strong enough to be successfully converted (e.g., converted with low error rate) to digital information. If, on the other hand, the signal strength is less than the adjusted receiver sensitivity, then the processor 12 may apply one or more desense mitigation procedures, according to process block 216, as the error rate (e.g., bit-error rate) may not be acceptable. Desense mitigation procedures may include disabling the aggressor (e.g., using regular charging instead of fast charging), enabling the aggressor during certain time periods that do not affect the victim receiver 54 (e.g., turning on fast charging when the signal is not being received during discontinuous reception (DRX) cycles), and/or receiving a signal with a frequency that is impacted by desense. Depending on the type of aggressor, desense mitigation measures may include transmitter blanking and/or changing the operating frequency of the aggressor.

It may be appreciated that, in order to maintain wireless communication link, the device 10 may continue receiving signals from the base station 106. In process block 217, the processor 12 causes the device 10 to receive the signal via the receiver 54. After the signal is received, the processor 12 may compare the signal strength to the adjusted receiver sensitivity, and repeat process blocks 214, 206, and 216. In addition, the signal strength of signals received from the base station 106 at different times may fluctuate depending on factors, such as the distance of the device 10 from the base station 106, structures that may block the signal, interference from other signals, transmission power of the base station 106, and so on. Each time a signal is received, the processor 12 may compare the signal strength to the adjusted receiver sensitivity and, based on the comparison, the processor 12 may determine whether to apply desense mitigation measures. For example, when the device 10 is close to the base station 106, the signal strength may be greater than or equal to the adjusted receiver sensitivity and the processor 12 may not apply the desense mitigation procedures. However, when the device 10 moves further away from the base station 106, and the signal strength decreases to below the adjusted receiver sensitivity, the processor 12 may apply the one or more desense mitigation procedures.

In some embodiments, the strength of wireless communication signal may include a moving average of the received signal (e.g., average of measurements/samples of the signal strength that falls in a time window of a certain number of seconds) added to a fading factor. Fading is a variation of a strength of the received signal that depends on a path that the signal took from a transmitter (e.g., of the base station 106) to the receiver 54. It may be caused by presence of reflectors that create multiple paths for the signal on the way to the receiver 54. As result of superposition of multiple copies of the transmitted signal, each signal copy may experience differences in attenuation, delay and/or phase shift while traveling from the transmitter to the receiver 54, resulting in constructive or destructive interference and amplifying or attenuating the signal power seen at the receiver 54. In addition, ionization density of the atmosphere of the different signal paths may contribute to the fading effect. The fading factor may include values from 5 dB to 15 dB, 6 dB to 12 dB, 7 dB to 10 dB, and so on.

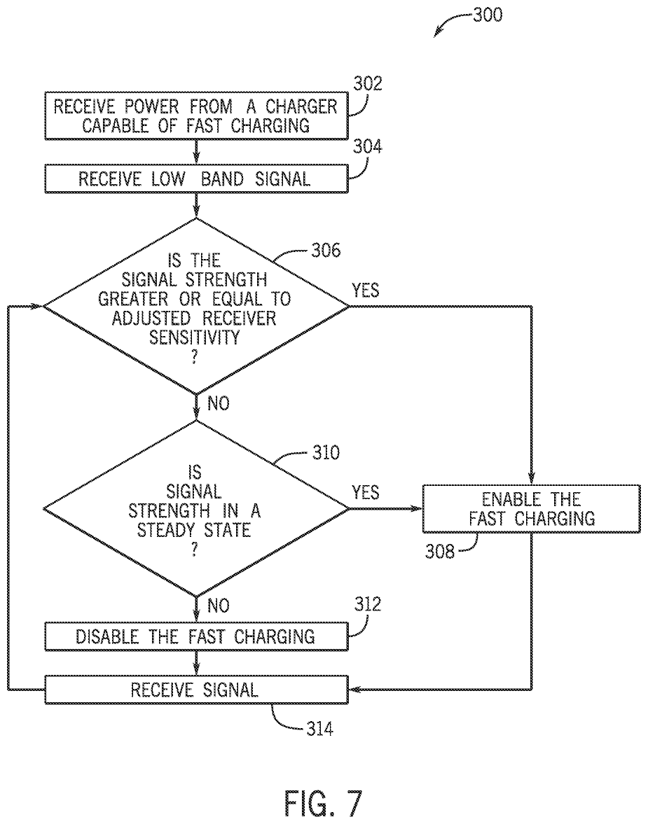

In an embodiment, the processor 12 may perform the method 200 to mitigate desense caused by fast charging in a smart watch. FIG. 7 is a flowchart of a method 300 mitigating a desense impact on the receiver 54 of the device 10 of FIG. 1 that is caused by fast charging, according to embodiments of the present disclosure. Any suitable device (e.g., a controller) that may control components of the electronic device 10, such as the processor 12, may perform the method 300. In some embodiments, the method 300 may be implemented by executing instructions stored in a tangible, non-transitory, computer-readable medium, such as the memory 14 or storage 16, using the processor 12. For example, the method 300 may be performed at least in part by one or more software components, such as an operating system of the electronic device 10, one or more software applications of the electronic device 10, and the like. While the method 300 is described using steps in a specific sequence, it should be understood that the present disclosure contemplates that the described steps may be performed in different sequences than the sequence illustrated, and certain described steps may be skipped or not performed altogether.

In a process block 302, the device 10 receives power from a charger capable of fast charging. Herein, fast charging may refer to charging that brings the power source 29 of the device 10 to 80% charge quicker than regular or standard charging. For example, to charge an approximately 310 milliamp hour (mAH) power source 29 from 10% to 80% using fast charging may take approximately 35 minutes, while normal or standard charging may take approximately 78 minutes.

In a process block 304, the device 10 receives a low band (e.g., low frequency, such as below 1 gigahertz (GHz)) signal via the receiver 54. Generally, low band signals may travel relatively long distances. Therefore, the device 10 may rely on low band signals for wireless communication when located further away from the base station 106. The receiver 54 receiving a low band signal may be affected by desense from fast charging. For this reason, in some cases, when the device 10 is turned on or activated (e.g., booted up) and is not placed in an airplane mode (e.g., a mode of operation where the transmitter 52 and the receiver 54 are disabled), the fast charging may be disabled as to not cause desense. It may be appreciated that desense may affect reception of the signal of any suitable frequency, such as a frequency less than 2 GHz, less than 5 GHz, less than 10 GHz, less than 100 GHz, a frequency in the cellular operating range (e.g., frequencies of 410 megahertz (MHz)-7125 MHz and 24250 MHz-52600 MHz), and so on, and that the low band signal is one specific example of the signal that may be affected. In addition, fast charging is just one example of the device operation that may cause desense of the receiver 54. As discussed, other device operations, such as refreshing of the display 18, may cause desense as well. Accordingly, in additional or alternative embodiments, the low band signal may instead be any signal having any suitable frequency, such as a frequency less than 2 GHz, less than 5 GHz, less than 10 GHz, less than 100 GHz, or a frequency in the cellular operating range, and reference to fast charging or any other aggressor may instead be any suitable device operation that may cause desense of the receiver 54 when receiving signals of the frequency.

In a process block 306, the processor 12 determines whether the signal strength is greater than or equal to the adjusted receiver sensitivity (e.g., sensitivity of the receiver 54 that is affected by desense). The adjusted receiver sensitivity may equal the receiver sensitivity without desense with the desense offset added. If the signal strength is greater than or equal to the adjusted receiver sensitivity, then the processor 12 may enable fast charging, according to a process block 308.

On the other hand, if the signal strength is below the adjusted receiver sensitivity, then the processor 12 determines whether the signal strength is in a steady state, according to process block 310. If the signal strength fluctuates (e.g., deviates from an average signal strength by a threshold signal strength), the signal strength may not be in a steady state. The signal strength may fluctuate, for example, due to the position of the device 10 changing with respect to the base station 106. For example, the device 10 that is in a moving vehicle, such as a car, boat, airplane, train, and so on, may not be in a steady state. If the signal strength is not in a steady state, the processor 12 disables fast charging, according to process block 312, as fluctuations in the signal strength may make the determination of whether the signal strength exceeds the adjusted receiver sensitivity short-lived or inaccurate over time. If the signal strength is in a steady state, the processor 12 enables fast charging in certain cases, according to process block 308.

In some embodiments, if the signal strength is in the steady state, the processor 12 may apply certain desense mitigation measures that enable or facilitate aggressor-victim coexistence. For example, certain desense mitigation measures may include enabling the receiver diversity (e.g., activating multiple antennas 55) of the device 10 and/or receiving the signal at a frequency that is not impacted by desense. If the signal strength is in a steady state, the processor 12 may evaluate or analyze the signal based on various criteria to determine which desense mitigation measures to apply. For example, if a signal strength is slightly lower than the adjusted receiver sensitivity (e.g., the signal strength is less than 5 dB lower than the adjusted receiver sensitivity), then the desense mitigation measure applied may include enabling receiver diversity (e.g., activating multiple antennas 55 of the device 10), which may increase the signal strength a level that is equivalent to or above the adjusted receiver sensitivity. However, if the signal strength is significantly lower than the adjusted receiver sensitivity (e.g., the signal strength close to the total isotropic sensitivity of the receiver 54), then the desense mitigation measure applied may involve receiving switching a frequency that is unimpacted by desense but that may have lower capacity. Applying additional mitigation measures may increase receiver sensitivity ensuring the coexistence of fast charging and the receiver 54 that is receiving a low band signal. In process block 314, the processor 12 causes the receiver 54 to receive the signal (e.g., a low band signal sent by the base station 106). Once the signal is received, the processor 12 may repeat process block 306, 308, 310 and 312 for continuous evaluation of subsequent signals, which may enable wireless communication with the base station 106.

The methods 200 and 300 for mitigating desense impact on the receiver 54 illustrate utilizing a single threshold (i.e., the adjusted receiver sensitivity) for determining whether desense mitigation measures should be applied. The general approach taken in methods 200 and 300 utilizes two signal strength ranges, the inner range 104 where desense mitigation measures are not applied, and the outer range 102 where desense mitigation measures are applied, as shown in FIG. 5. While this does provide an improvement over existing approaches by enabling or facilitating aggressor-victim coexistence when the signal strength exceeds the adjusted receiver sensitivity, the following embodiments may increase or maximize aggressor-victim coexistence while mitigating desense impact. For example, the approach introduced in FIG. 6 may be expanded to include multiple thresholds for applying different desense mitigation measures. Indeed, some desense mitigation measures, such as disabling the aggressor, may be more beneficial when desense has a stronger impact on the receiver 54, while other desense mitigation measures, such as selectively enabling the aggressor only at certain times, may be more beneficial when the desense impact on the receiver 54 is less or moderate.

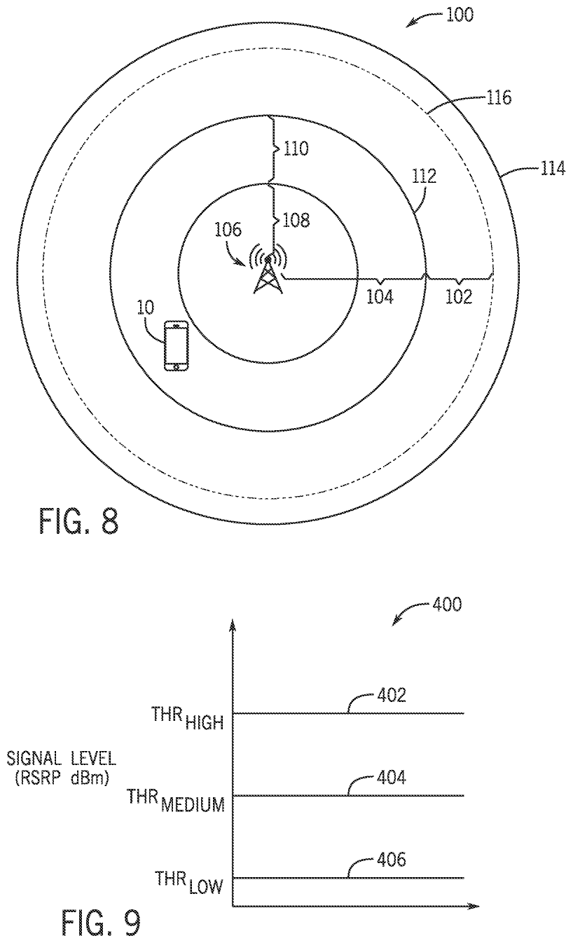

FIG. 8 is a schematic diagram 100 of signal strength ranges for which to apply desense mitigation techniques, according to embodiments of the present disclosure. A full signal coverage area, defined by boundary 114 (e.g., a cell edge) of a base station 106, may include several signal strength ranges. A high signal strength range 108 includes an area nearest the base station 106. In the high signal strength range 108, the signal strength may be strong or good, even when the receiver 54 is affected by desense. For example, the high signal strength range 108 may correspond to where the signal strength is −100 dBm and above. Further from the base station 106, the medium signal strength range 110 includes signal strength lower than what is considered “good,” but high enough for the signal in this range to be transmitted with a sufficient bit error rate. Taken together, the high signal strength range 108 and the medium signal strength range 110 may constitute the inner range 104 shown in FIG. 5. Furthest from the base station 106 is the outer range 102, where the signal strength is below the adjusted receiver sensitivity, and, therefore, digital information may not be extracted from the signal with a sufficient level of accuracy when desense is present. The outer range 102 is defined by two boundaries: inner boundary 112 and outer boundary 116. The outer boundary 116 may represent a distance from the base station 106 where the signal strength equals total isotropic sensitivity of the receiver 54 (e.g., receiver sensitivity without desense) and the inner boundary 112 may represent a distance from the base station 106 where the signal strength may equal the total isotropic sensitivity plus the desense offset (e.g., adjusted receiver sensitivity). Applying desense mitigation procedures may push the inner boundary 112 further from the base station 106 toward the outer boundary 116. In an ideal scenario, if the application of desense mitigation measures completely negate the desense impact, the inner boundary 112 may reach and completely overtake the outer boundary 116.

FIG. 9 is a graph 400 of signal strength thresholds corresponding to the signal strength ranges illustrated in FIG. 8, according to embodiments of the present disclosure. The signal strength thresholds may be expressed in terms of reference signal received power (RSRP). Signal strength thresholds may also or alternatively be expressed in terms of other measurements of signal strength and/or quality, such as signal-to-noise ratio (SNR), reference signal received quality (RSRQ), received signal strength indicator (RSSI), and so on. In general, the signal strength thresholds correspond to signal power levels that enable the receiver 54 to achieve a certain bit error rate performance when the signal is converted to digital information.

The high threshold 402, Thr_{HIGH}, defines signal RSRP corresponding to good or strong signal coverage. If the RSRP of a signal is equal to or higher than the high threshold 402, Thr_{HIGH}, then the signal is of good quality and minimum amount of information in the signal is lost to noise at the receiver 54. In an embodiment, the high threshold 402 may correspond to −120 dBm or greater, −110 dBm or greater, −100 dBm or greater, −90 dBm or greater, −80 dBm or greater, or the like, such as −100 dBm.

The medium threshold 404, Thr_{MEDIUM}, defines a signal RSRP that corresponds adjusted receiver sensitivity or to the total isotropic sensitivity of the receiver with the desense offset added. If the RSRP of a signal is equal to or higher than the medium threshold 404, Thr_{MEDIUM}, then the signal is strong enough to be received by the receiver 54 with acceptable bit level of signal noise, even when the receiver 54 is affected by desense. In an embodiment, the medium threshold 404 may correspond to −130 dBm or greater, −120 dBm or greater, −110 dBm or greater, −100 dBm or greater, −90 dBm or greater, or the like, such as −110 dBm.

The low threshold 406, Thr_{LOW}, defines a signal RSRP corresponding to the lowest sensitivity of the receiver 54 of the device 10. In particular, the low threshold 406 may correspond to the total isotropic sensitivity of the receiver 54 (not affected by desense). If the signal power received is below the low threshold 406, the receiver 54 may not be able to extract digital information from the signal with sufficient error rate. In an embodiment, the low threshold 406 may correspond to −150 dBm or greater, −140 dBm or greater, −130 dBm or greater, −120 dBm or greater, −110 dBm or greater, −100 dBm or greater, or the like, such as −125 dBm. The difference in RSRP between the medium threshold 404 and the low threshold 406 corresponds to the desense offset. For example, when medium threshold 404 corresponds to −110 dBm and desense offset corresponds to 15 dB, the low threshold 406 is −125 dBm.

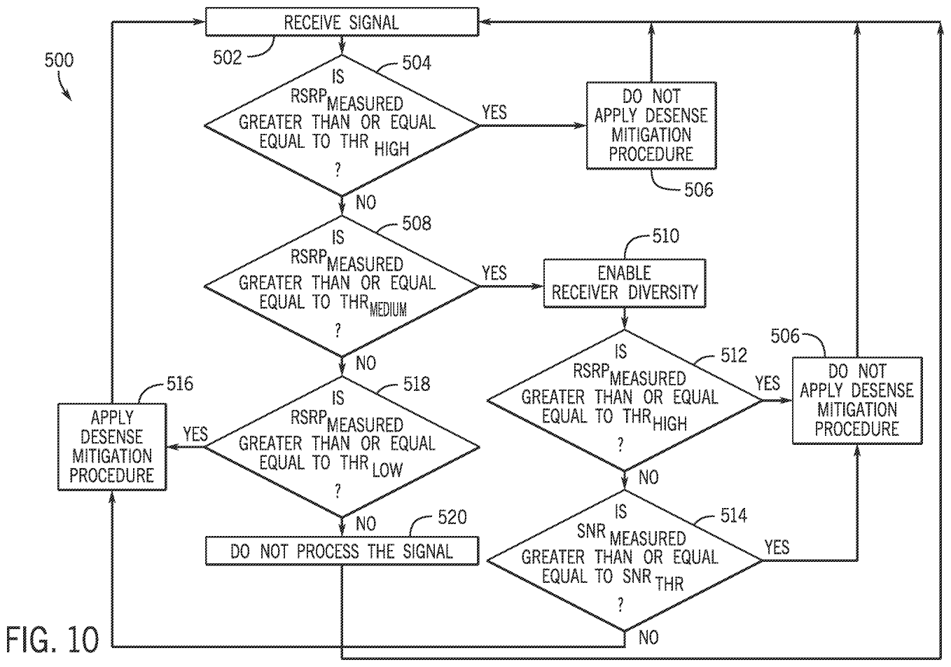

FIG. 10 is a flowchart of a method 500 for applying different desense mitigation techniques based on the strength of the signal received by the receiver 54 falling within the thresholds illustrated in FIG. 9, according to embodiments of the present disclosure. The method 500 may be viewed as an expanded version of methods 200 and 300 that includes additional criteria for application of certain desense mitigation measures. Any suitable device (e.g., a controller) that may control components of the electronic device 10, such as the processor 12, may perform the method 500. In some embodiments, the method 500 may be implemented by executing instructions stored in a tangible, non-transitory, computer-readable medium, such as the memory 14 or storage 16, using the processor 12. For example, the method 500 may be performed at least in part by one or more software components, such as an operating system of the electronic device 10, one or more software applications of the electronic device 10, and the like. While the method 500 is described using steps in a specific sequence, it should be understood that the present disclosure contemplates that the described steps may be performed in different sequences than the sequence illustrated, and certain described steps may be skipped or not performed altogether.

In the process block 502, the processor 12 causes the receiver 54 of the device 10 to receive a signal. In an embodiment, the signal is a low band signal (e.g., a signal with a frequency below 1 GHz) with the frequency corresponding to the operating frequency of the receiver 54. In additional or alternative embodiments, the signal may have any suitable frequency, such as a frequency less than 2 GHz, less than GHz, less than 10 GHz, less than 100 GHz, a frequency in the cellular operating range (e.g., frequencies of 410 megahertz (MHz)-7125 MHz and 24250 MHz-52600 MHz), and so on, and reference to fast charging or any other aggressor may instead be any suitable device operation that may cause desense of the receiver 54 when receiving signals of the frequency. The signal may be analyzed by the internal components of the device 10 and the various properties of the signal, such as RSRP, may be measured.

In the process block 504, the processor 12 determines whether the RSRP of the signal, RSRP_{MEASURED}, is greater than or equal to the high threshold 402, Thr_{HIGH}. If the RSRP_{MEASURED} is greater than or equal to the high threshold 402, then, according to process block 506, the processor 12 does not apply desense mitigation measures as the signal strength is high enough relative to receiver sensitivity for the signal to have good quality, even when the receiver sensitivity is reduced by desense. In this case, the aggressor and the victim may coexist without application of any desense mitigation measures.

If the RSRP_{MEASURED} is less than the high threshold 402, then the processor 12 determines whether the RSRP_{MEASURED} is greater than or equal to the medium threshold 404 (e.g., adjusted receiver sensitivity), according to process block 508. If the processor 12 determines that the RSRP_{MEASURED} is greater than or equal to the medium threshold 404, then the processor 12 may cause the device 10 to enable receiver diversity, according to the process block 510. Enabling the receiver diversity may include activating or turning on multiple antennas 55 of the device 10 electrically coupled to the receiver 54. Enabling the receiver diversity may ensure that multiple versions or instances of the signal may be received and combined in the receiver 54. This may improve the quality and reliability of the signal by increasing gain of the received signal using the multiple antennas, effectively increasing signal strength and thus increasing the adjusted receiver sensitivity of the receiver 54.

Once the receiver diversity has been enabled, in a process block 512, the processor 12 determines whether the RSRP_{MEASURED} is greater than or equal to the high threshold 402, Thr_{HIGH}. If the RSRP_{MEASURED} is greater than or equal to the high threshold 402, then the processor 12 does not apply desense mitigation measures, according to process block 506. However, if the RSRP_{MEASURED} is less than the high threshold 402, then the processor 12 determines whether the signal-to-noise ratio (SNR) of the signal, SNR_{MEASURED}, is greater than or equal to the SNR threshold, SNR_{THR}, according to the process block 514. The SNR threshold, SNR_{THR}, may be used to determine whether the signal is of high enough quality and whether a certain amount of information carried by the signal may be lost due to noise. If the SNR_{MEASURED} is greater than or equal to the SNR threshold, SNR_{THR}, then the processor 12 does not apply the desense mitigation measures, according to process block 506, as signal has low enough noise to be of high quality. However, if the SNR_{MEASURED} is less than the SNR threshold, SNR_{THR}, according to process block 516, then the processor 12 applies one or more desense mitigation measures, as too much information in the signal may be lost to noise.

For example, if the SNR_{MEASURED} is below the SNR_{THR}, desense mitigation measures may include opportunistic enablement of the aggressor technology. Generally, opportunistic enablement of aggressor technology may include enablement of the aggressor technology in a way that may not interfere with the reception of the wireless signal. In particular, the aggressor technology may be activated or turned on during times when the signal is not being transmitted by the base station 106 and/or received by the receiver 54 of the device 10. For example, an aggressor, such as fast charging, may be activated or turned on during pauses in data transmission (e.g., voice over long-term evolution (VoLTE) data transmission) of a semi-persistent scheduling (SPS) scheme Similarly, the aggressor (e.g., fast charging) may be enabled during sleep or idle cycles (e.g., times when data-carrying signals are not being transmitted and/or received) of discontinuous reception (DRX), connected mode discontinuous reception (CDRX), and/or extended discontinuous reception (eDRX) scheduling schemes. For instance, in an extended DRX scheduling scheme, sleep cycles may range from 5.12 seconds to 48 minutes. It may be appreciated that enablement or activation of certain aggressors for 5.12 seconds to 48 minutes may be enough to complete operation of the certain aggressors. For example, if the eDRX cycle lasts about 30 minutes, the power source 29 of the device 10 may be charged to a sufficient capacity (e.g., charge of 80% or above) via fast charging during that time. It may be appreciated that the opportunistic enablement of the aggressor may be performed for many types of aggressors. For example, in the case where a memory-intensive application on the device 10 acts as an aggressor, the processor 12 may access the memory 14 only during the times when the signal is not being transmitted or received according to the scheduling scheme (e.g., SPS, DRX, CDRX, eDRX).

According to the process block 516, the processor 12 may also cause desense mitigation measures to be applied if the RSRP_{MEASURED} is greater than or equal to the low threshold 406, Thr_{LOW}. According to the process block 518, the evaluation by the processor 12 of whether RSRP_{MEASURED} is greater than or equal to the low threshold, Thr_{LOW}, 406 is triggered if the RSRP_{MEASURED}, is less than the medium threshold 404, Thr_{MEDIUM}. If the RSRP_{MEASURED} is greater than or equal to the low threshold 406 and less than the medium threshold 404, the processor 12 may apply the desense mitigation measures that may include opportunistic enablement of the device 10 operation that might otherwise cause desense (e.g., if the receiver 54 was active) and/or receiving the signal at a frequency that is unimpacted by desense. That is, if the receiver 54 with a certain operating frequency is affected by desense, the receiver 54 may switch to receiving signals of different frequency as a desense mitigation solution. It should be understood that, in certain cases, such signals of frequency impacted by desense may be weaker and/or may carry less information. For example, if low band frequency is impacted by desense, the receiver 54 may switch to receiving signals with frequency in the mid-band. However, low-band signals tend to travel further than mid-band signals, so mid-band signals may not have as good of a coverage. Nevertheless, if reception of low band signals is strongly affected by desense, signals with other frequency bands may transmit information with lower error rate, at least temporarily.

If the RSRP_{MEASURED} is less than the low threshold 406, Thr_{LOW}, then the processor 12 causes the receiver 54 to not process the signal, according to a process block 520. If the signal is weaker than the low threshold 406, the power of the signal is less than the total isotropic sensitivity of the receiver 54 and, therefore, may not relay information reliably (e.g., with sufficiently low error rate). In this case, not processing the signal may save power and resources consumed by the receiver 54.

It may be appreciated that the signal strength (e.g., RSRP_{MEASURED}) may fluctuate with time, as well as with position of the device 10 relative to the base station 106. Moreover, enabling receiver 54 diversity and applying other mitigation measures may result in the signal being received with better quality. For these reasons, among others, evaluation of the signal may be continuous (e.g., repeated multiple times at certain time intervals). In the process block 502, the device 10 receives the signal and the method 500 may be repeated.

It may be appreciated that the embodiments provided herein may not be limited to handling of desense impacts. The processor 12 may perform methods 200, 300, and 500 to apply mitigation measures for other issues that affect wireless communication by devices 10, such as RF coexistence issues. RF coexistence may refer to operation of different wireless devices 10 and standards in the same frequency band. RF coexistence issues may arise when radio frequency signals sent and/or received by the devices 10 interfere with one another (e.g., due to harmonics, constructive/destructive interference, and so on). For example, the embodiments provided above may be used to mitigate coexistence issues between electronic devices 10 using Wi-Fi and Bluetooth, electronic devices 10 using an ultra-wideband (UWB) channel (e.g., UWB channel 9) and a cellular frequency band (e.g., LTE band 41), electronic devices 10 using LTE Citizens Broadband Radio Service (CBRS) and frequency selective scheduling (FSS), and so on.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device comprising:
a first receiver;
a second receiver; and
processing circuitry coupled to the first receiver and the second receiver, the processing circuitry configured to
cause the first receiver of the electronic device to receive a first signal with a frequency,
apply a desense mitigation procedure based on a power level of the first signal being greater than or equal to a low power threshold and less than a medium power threshold,
cause the first receiver and the second receiver to receive a second signal based on the power level of the first signal being greater than or equal to the medium power threshold and less than a high power threshold, and
apply the desense mitigation procedure based on the power level of the first signal being greater than or equal to the medium power threshold and less than the high power threshold and based on a signal-to-noise ratio of the second signal being less than a signal-to-noise ratio threshold.

2. The electronic device of claim 1, wherein the desense mitigation procedure comprises disabling one or more device operations operating on a second frequency or generates a harmonic frequency that overlaps with the frequency.

3. The electronic device of claim 1, wherein the desense mitigation procedure comprises enabling fast charging during sleep cycles of a signal transmission scheduling scheme.

4. The electronic device of claim 3, wherein the signal transmission scheduling scheme comprises discontinuous reception, connected mode discontinuous reception, extended discontinuous reception, semi-persistent scheduling, or a combination thereof.

5. The electronic device of claim 1, wherein the high power threshold corresponds to the power level that is greater than the power level that corresponds to the medium power threshold.

6. The electronic device of claim 1, wherein the medium power threshold corresponds to the power level that is equivalent to total isotropic sensitivity of the first receiver and desense offset.

7. The electronic device of claim 1, wherein the low power threshold corresponds to the power level that is equivalent to a total isotropic sensitivity of the first receiver.

8. The electronic device of claim 1, wherein the frequency is below 1 gigahertz.

9. One or more tangible, non-transitory, computer-readable media, comprising instructions that cause processing circuitry of a receiving device to:
cause a first receiver of the receiving device to receive a first signal with a first frequency;
apply a first desense mitigation procedure based on a strength level of the first signal being greater than or equal to a low strength threshold and less than a medium strength threshold;
cause the first receiver and a second receiver to receive a second signal with the first frequency based on the strength level of the first signal being greater than or equal to the medium strength threshold and less than a high strength threshold; and
apply a second desense mitigation procedure based on the strength level of the first signal being greater than or equal to the medium strength threshold and less than the high strength threshold and based on a signal-to-noise ratio of the second signal being less than a signal-to-noise ratio threshold.

10. The one or more tangible, non-transitory, computer-readable media of claim 9, wherein the instructions cause the processing circuitry to apply no desense mitigation procedure based on the signal-to-noise ratio of the second signal being greater than or equal to the signal-to-noise ratio threshold.

11. The one or more tangible, non-transitory, computer-readable media of claim 9, wherein the instructions cause the processing circuitry to apply no desense mitigation procedure based on the strength level of the second signal being greater than or equal to the high strength threshold.

12. The one or more tangible, non-transitory, computer-readable media of claim 9, wherein the instructions cause the processing circuitry to not process the first signal based on the strength level of the first signal being less than the low strength threshold.

13. The one or more tangible, non-transitory, computer-readable media of claim 9, wherein the instructions cause the processing circuitry to apply no desense mitigation procedure based on the strength level of the first signal being greater than or equal to the high strength threshold.

14. The one or more tangible, non-transitory, computer-readable media of claim 9, wherein the instructions that cause the processing circuitry to apply the second desense mitigation procedure comprise receiving a third signal with a second frequency.

15. One or more tangible, non-transitory, computer-readable media, comprising instructions that cause processing circuitry of a receiving device to:
cause a first receiver of a receiving device to receive a first signal;
not process the first signal based on a power level of the first signal being less than a low power threshold;
cause the first receiver and a second receiver to receive a second signal based on the power level of the first signal being greater than or equal to a medium power threshold and less than a high power threshold; and
apply a desense mitigation procedure based on the power level of the first signal being greater than or equal to the medium power threshold and less than the high power threshold and based on a signal-to-noise ratio of the second signal being less than a signal-to-noise ratio threshold.

16. The one or more tangible, non-transitory, computer-readable media of claim 15, wherein the instructions that cause the processing circuitry to apply the desense mitigation procedure comprise enabling fast charging during sleep cycles of a signal transmission scheduling scheme.

17. The one or more tangible, non-transitory, computer-readable media of claim 16, wherein the signal transmission scheduling scheme comprises discontinuous reception, connected mode discontinuous reception, extended discontinuous reception, semi-persistent scheduling, or a combination thereof.

18. The one or more tangible, non-transitory, computer-readable media of claim 15, wherein the instructions that cause the processing circuitry to apply the desense mitigation procedure comprise determining that the first signal, the second signal, or both are in a steady state.

19. The one or more tangible, non-transitory, computer-readable media of claim 15, wherein the instructions cause the processing circuitry to apply the desense mitigation procedure based on the power level of the first signal being greater than or equal to the low power threshold and less than the medium power threshold.

20. The one or more tangible, non-transitory, computer-readable media of claim 15, wherein the instructions cause the processing circuitry to not apply the desense mitigation procedure based on the signal-to-noise ratio of the second signal being greater than or equal to the signal-to-noise ratio threshold.
